(19) United States
(12) Patent Application Publication
(10) Pub. No.: US 2015/0261603 A1
(43) Pub. Date: Sep. 17, 2015

(54) NONVOLATILE SEMICONDUCTOR MEMORY DEVICE AND CONTROL METHOD THEREOF

(71) Applicant: KABUSHIKI KAISHA TOSHIBA, Minato-ku (JP)

(72) Inventors: Toshitake YAEGASHI, Yokkaichi-shi (JP); Osamu TORII, Setagaya-ku (JP)

(73) Assignee: KABUSHIKI KAISHA TOSHIBA, Minato-ku (JP)

(21) Appl. No.: 14/293,572

(22) Filed: Jun. 2, 2014

Related U.S. Application Data
(60) Provisional application No. 61/951,838, filed on Mar. 12, 2014.

(51) Int. Cl. G06F 11/10

(52) U.S. Cl. CPC G06F 11/1068

(57) ABSTRACT

The word line includes a first word line which is connected to the memory cell configured capable of storing data of a first bit number and a second word line which is connected to the memory cell configured capable of storing data of a second bit number which is smaller than the first bit number. The control circuit is configured to store in the memory cell connected to the first word line user data capable of being arbitrarily rewritten by a user and a parity for performing error correction on the user data. The control circuit is configured to store in the memory cell connected to the second word line not only the parity but also a first external parity for performing error correction on the user data.

### CROSS REFERENCE TO RELATED APPLICATIONS

This application is based on and claims the benefit of priority from prior U.S. Provisional Patent Application No. 61/951,838, filed on Mar. 12, 2014, the entire contents of which are incorporated herein by reference.

### BACKGROUND

1. Field

Embodiments described below relate to a nonvolatile semiconductor memory device and a control method thereof.

2. Description of the Related Art

A NAND type flash memory is known as a nonvolatile semiconductor memory device which is electrically rewritable and capable of being highly integrated. A memory cell of the NAND type flash memory includes a charge accumulation layer formed on a semiconductor substrate via a tunnel insulating film and a control gate stacked on the charge accumulation layer via an inter-gate insulating film. The memory cell stores data in a nonvolatile manner by a charge accumulation state of the charge accumulation layer.

In this NAND type flash memory, an error during a read operation is corrected based on parity data. When performing the read operation on the memory cell, data must be accurately corrected.

### BRIEF DESCRIPTION OF THE DRAWINGS

FIG. 1 is a block diagram of a nonvolatile semiconductor memory device according to a first embodiment.

FIG. 2 is a circuit diagram showing a memory cell array and a peripheral circuit of the nonvolatile semiconductor memory device according to the first embodiment.

FIG. 3A is a view showing threshold voltage distributions of a memory cell of the nonvolatile semiconductor memory device according to the first embodiment.

FIG. 3B is a view showing threshold voltage distributions of a memory cell of the nonvolatile semiconductor memory device according to the first embodiment.

FIG. 3C is a view showing threshold voltage distributions of a memory cell of the nonvolatile semiconductor memory device according to the first embodiment.

FIG. 4 is a view explaining a storage state of data of the nonvolatile semiconductor memory device according to the first embodiment.

FIG. 5 is a view explaining a storage state of data of the nonvolatile semiconductor memory device according to another example of the first embodiment.

FIG. 6 is a view explaining a storage state of data of the nonvolatile semiconductor memory device according to another example of the first embodiment.

FIG. 7 is a circuit diagram showing a memory cell array of a nonvolatile semiconductor memory device according to a second embodiment.

FIG. 8 is a circuit diagram showing a memory cell array of the nonvolatile semiconductor memory device according to another example of the second embodiment.

FIG. 9 is a circuit diagram showing a memory cell array of a nonvolatile semiconductor memory device according to a third embodiment.

FIG. 10 is a circuit diagram showing the memory cell array of the nonvolatile semiconductor memory device according to the third embodiment.

FIG. 11 is a circuit diagram showing the memory cell array of the nonvolatile semiconductor memory device according to another example of the third embodiment.

FIG. 12 is a circuit diagram showing a memory cell array of a nonvolatile semiconductor memory device according to a fourth embodiment.

FIG. 13 is a circuit diagram showing the memory cell array of the nonvolatile semiconductor memory device according to another example of the fourth embodiment.

FIG. 14 is a circuit diagram showing a memory cell array of a nonvolatile semiconductor memory device according to a fifth embodiment.

FIG. 15 is a circuit diagram showing the memory cell array of the nonvolatile semiconductor memory device according to another example of the fifth embodiment.

### DETAILED DESCRIPTION

A nonvolatile semiconductor memory device according to an embodiment comprises: a memory cell array having a plurality of NAND strings arranged therein, each of the NAND strings including a memory string having a plurality of memory cells connected in series therein and a first select transistor and a second select transistor respectively connected to both ends of the memory string; a plurality of word lines respectively connected to control gate electrodes of the plurality of memory cells; a plurality of select gate lines respectively connected to control gate electrodes of the first select transistor and the second select transistor; and a control circuit that controls data stored in the plurality of memory cells. The wordline includes a first word line which is connected to the memory cell configured capable of storing data of a first bit number and a second word line which is connected to the memory cell configured capable of storing data of a second bit number which is smaller than the first bit number. The control circuit is configured to store in the memory cell connected to the first word line user data capable of being arbitrarily rewritten by a user and a parity for performing error correction on the user data. The control circuit is configured to store in the memory cell connected to the second word line not only the parity but also a first external parity for performing error correction on the user data.

A nonvolatile semiconductor memory device according to embodiments will be described below with reference to the drawings.

### First Embodiment

### Overall Configuration

First, an overall configuration of a nonvolatile semiconductor memory device according to a first embodiment will be described.

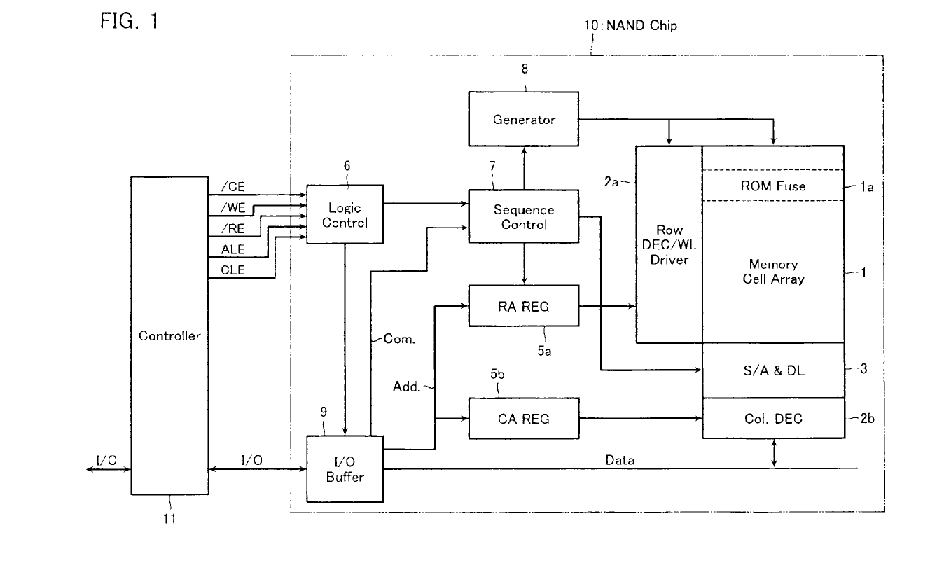

FIG. 1 is a block diagram of the nonvolatile semiconductor memory device according to the present embodiment.

This NAND type flash memory comprises a NAND chip 10 and a controller 11 that controls this NAND chip 10.

As will be described later, a memory cell array 1 configuring the NAND chip 10 is configured having a plurality of memory cells arranged in a matrix therein, each of the memory cells including a charge accumulation layer. Stored in the memory cell array 1 are user data on which write and erase of data can be arbitrarily performed by a user, a parity for performing error correction of the user data, and so on. This memory cell array 1 may be provided with a ROM fuse region 1a inaccessible from the user, as required. Stored in this ROM fuse region 1a are various kinds of information required in control of the device during data write, and so on.

Disposed in a periphery of the memory cell array 1 are a row decoder/word line driver 2a, a column decoder 2b, a sense amplifier/data latch 3, and a voltage generating circuit 8. These row decoder/word line driver 2a, column decoder 2b, sense amplifier/data latch 3, and voltage generating circuit 8 configure a data write unit, and perform write or read of data in page units on the memory cell array 1.

The row decoder/word line driver 2a drives a word line and a select gate line of the memory cell array 1. The sense amplifier/data latch 3 comprises a one page portion of sense amplifier circuits and data holding circuits. A one page portion of read data of the sense amplifier/data latch 3 is sequentially column-selected by the column decoder 2b to be outputted to an external I/O terminal via an I/O buffer 9. Write data supplied from an I/O terminal is selected by the column decoder 2b to be loaded into the sense amplifier/data latch 3. A one page portion of write data is loaded into the sense amplifier/data latch 3. A row address signal and a column address signal are inputted via the I/O buffer 9 and respectively transferred to the row decoder/word line driver 2a and the column decoder 2b. A row address register 5a holds an erase block address or holds a page address. A column address register 5b is inputted with a lead column address for write data load before write sequence start or with a lead column address for a read sequence. The column address register 5b holds the inputted column address until a write enable signal /WE or a read enable signal /RE is toggled by a certain condition.

A logic control circuit 6 receives a command such as a control signal of the likes of a chip enable signal /CE, a command enable signal CLE, an address latch enable signal ALE, the write enable signal /WE, and the read enable signal /RE that are transmitted from the controller 11. Input of the address and input/output of data are controlled based on this command. Moreover, on receiving the command, the logic control circuit 6 issues an instruction to a sequence control circuit 7 to perform sequence control of a read operation or of write or erase. The voltage generating circuit 8 is controlled by the sequence control circuit 7 to generate certain voltages required in various kinds of operations.

The controller 11 executes control of write and read of data by a condition appropriate to a current write state of the NAND chip 10. Note that part of error correction during the later-described read operation may be configured to be performed on a NAND chip 10 side.

[Memory Cell Array]

Next, the memory cell array 1 of the nonvolatile semiconductor memory device according to the present embodiment will be described.

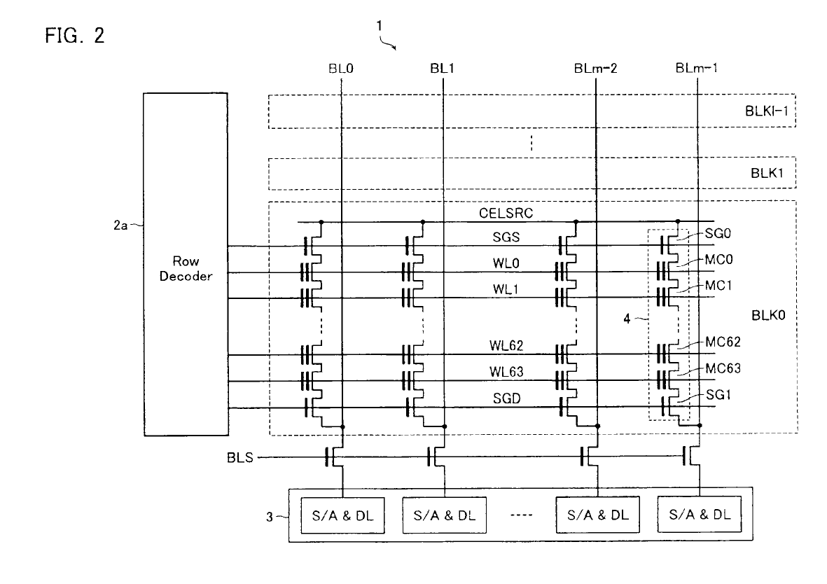

FIG. 2 is a circuit diagram of the memory cell array 1 and a peripheral circuit. In the case of FIG. 2, a NAND string 4 is configured by, for example, 64 series-connected memory cells MC0 to MC63 and select gate transistors SG0 and SG1 connected to both ends of these series-connected memory cells MC0 to MC63. A source of the select gate transistor SG0 is connected to a common source line CELSRC, and a drain of the select gate transistor SG1 is connected to m (m is a natural number) bit lines BL (BL0 to BLm−1). Control gates of the memory cells MC3 to MC63 are respectively connected to word lines WL (WL0 to WL63), and gates of the select gate transistors SG0 and SG1 are connected to select gate lines SGS and SGD.

The plurality of memory cells MC shared by one word line WL form a page which is a unit of batch read and write of data. Moreover, the plurality of NAND strings 4 aligned in a word line WL direction configure a block BLK which is a unit of batch erase of data. In FIG. 2, 1 (1 is a natural number) blocks BLK0 to BLK1−1 are arranged such that NAND strings 4 adjacent in a bit line BL direction share the bit line BL, thereby configuring the memory cell array 1. The word lines WL and the select gate lines SGS and SGD are driven by the row decoder/word line driver 2a. Each of the bit lines BL is connected to a sense amplifier circuit S/A of the sense amplifier/data latch 3.

[Data Storage State of Memory Cell]

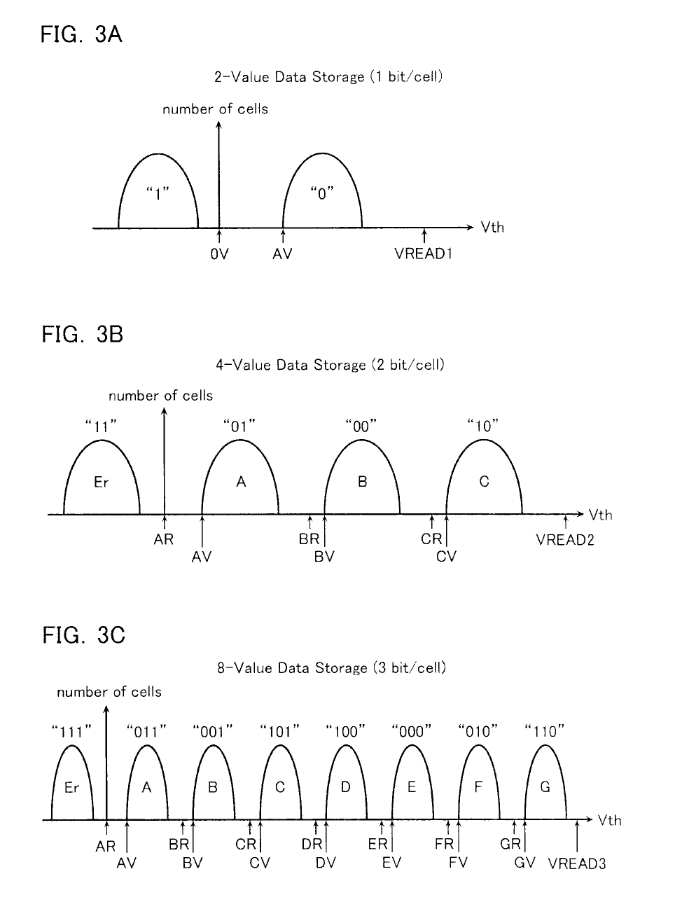

Next, a data storage state of the memory cell of the NAND type flash memory according to the present embodiment will be described. FIGS. 3A to 3C are views showing threshold voltage distributions of the memory cell MC of the NAND type flash memory according to the present embodiment.

In the case where the memory cells MC of the NAND type flash memory store 2-value data (1 bit/cell), the threshold voltage distributions of data are as in FIG. 3A. A state where the threshold voltage is negative is data “1” (erase state), and a state where the threshold voltage is positive is data “0”.

In addition, a voltage VREAD1 during 2-value data storage is a voltage which is higher than an upper limit of the highest threshold voltage distribution. This read pass voltage VREAD1 is a voltage applied to an unselected word line WL during the read operation or a write verify operation.

Moreover, in the case where the memory cell MC of the NAND type flash memory stores 4-value data (2 bits/cell), the threshold voltage distributions of data are as in FIG. 3B. In this case, four kinds of threshold voltage distributions (Er, A, B, and C) are provided, in order from the lowest threshold voltage. Allocated to these threshold voltage distributions are four types of data, namely “11”, “01”, “00”, and “10”. Now, the threshold voltage distribution Er is a negative threshold voltage state obtained by batch block erase during the erase operation. Moreover, voltages AR, BR, and CR between the threshold voltage distributions are determining voltages during the read operation. Voltages AV, BV, and CV of lower limits of the positive threshold voltage distributions are determining voltages during the write verify operation.

In addition, a voltage VREAD2 during 4-value data storage is a voltage which is higher than an upper limit of the highest threshold voltage distribution. This read pass voltage VREAD2 is a voltage applied to the unselected word line WL during the read operation or the write verify operation.

Moreover, in the case where the memory cell MC of the NAND type flash memory stores 8-value data (3 bits/cell), the threshold voltage distributions of data are as in FIG. 3C. In this case, eight kinds of threshold voltage distributions (Er, A, B, C, D, E, F, and C) are provided, in order from the lowest threshold voltage. Allocated to these threshold voltage distributions are eight types of data, namely “111”, “011”, “001”, “101”, “100”, “000”, “010”, and “110”. Now, the threshold voltage distribution Er is a negative threshold voltage state obtained by batch block erase during the erase operation. Moreover, voltages AR, BR, CR, DR, ER, FR, and GR between the threshold voltage distributions are determining voltages during the read operation. Voltages AV, BV, CV, DV, EV, FV, and GV of lower limits of the positive threshold voltage distributions are determining voltages during the write verify operation.

In addition, a voltage VREAD3 during 8-value data storage is a voltage which is higher than an upper limit of the highest threshold voltage distribution. This read pass voltage VREAD3 is a voltage applied to the unselected word line WL during the read operation or the write verify operation.

A “page” which is an access unit of this kind of NAND type flash memory will now be described. In the description below, “page” has two different meanings, hence care is required.

First, there is “page” as a data access unit configured from the plurality of memory cells MC shared by one word line. Then second, there is “page” indicating hierarchy of stored data in the case where multiple bits are stored in one memory cell. In this case, a symbol “L” indicating lower page data, a symbol “M” indicating middle page data, and a symbol “U” indicating upper page data, and so on, are sometimes assigned.

[Data Storage State of Memory Cell Array]

Next, a storage state of data of the memory cell MC provided in the memory cell array 1 in the present embodiment will be described. Stored in the memory cell MC provided in the memory cell array 1 are user data capable of being arbitrarily rewritten by a user or a parity employed in error correction of the user data. It will be described below how the user data and the parity are stored in the memory cell array 1.

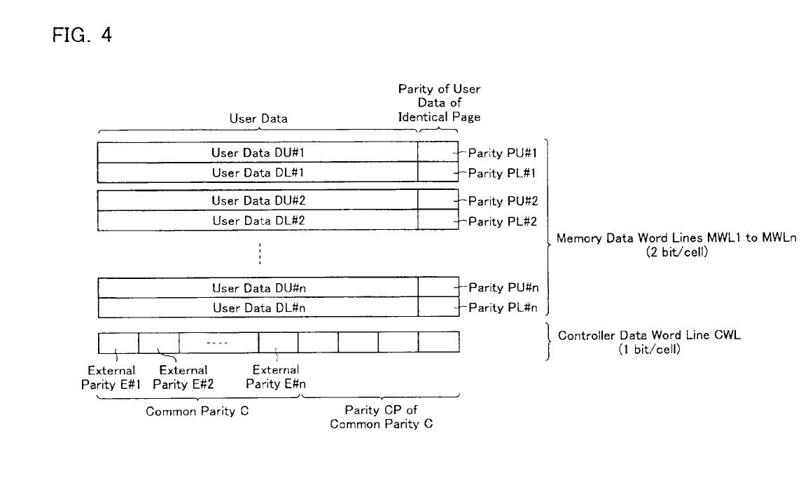

FIG. 4 is a view explaining the storage state of data of the nonvolatile semiconductor memory device according to the present embodiment. FIG. 4 shows schematically the memory cell array 1 described in FIG. 2, and it is assumed there are a plurality of word lines WL extending in a horizontal direction of FIG. 4.

In the present embodiment, the word lines WL provided in the memory cell array 1 are divided into two kinds of word lines. As shown in FIG. 4, some of the word lines WL provided in the memory cell array 1 are employed as memory data word lines MWL, and others of the word lines WL provided in the memory cell array 1 are employed as controller data word lines CWL.

In the present embodiment, a value (the number of bits) of stored data differs between the memory cell MC connected to the memory data word line MWL and the memory cell MC connected to the controller data word line CWL. In the present embodiment, the memory cells MC connected to the memory data word line MWL store 4-value data (2 bits/cell). Moreover, the memory cells MC connected to the controller data word line CWL store 2-value data (1 bit/cell).

Now, a positional relationship of the memory data word line MWL and the controller data word line CWL is not necessarily limited to the memory data word lines MWL being provided aggregated and the controller data word line CWL being provided adjacent to those memory data word lines MWL. The memory data word lines MWL and the controller data word lines CWL may be allocated arbitrarily to the word lines WL in the memory cell array. Moreover, the controller data word line CWL is not limited to one, and a plurality of the controller data word lines CWL may be provided.

Stored in the plurality of memory cells MC connected to a certain one memory data word line MWL are, for example, user data DU#1 and DL#1 and parities PU#1 and PL#1. Now, the memory cells MC connected to the memory data word line MWL can store 4-value data (2 bits/cell). Therefore, the user data and parities stored in the memory cell MC connected to the memory data word line MWL are shown as the user data DU#1 and the parity PU#1 stored in an upper page, and the user data DL#1 and the parity PL#1 stored in a lower page.

In the example shown in FIG. 4, n (n is a natural number) memory data word lines MWL are provided. Stored respectively in the n memory data word lines MWL1 to MWLn are the user data DU#1 and DL#1 and the parities PU#1 and PL#1 to the user data DU#n and DL#n and the parities PU#n and PL#n.

Moreover, stored in the plurality of memory cells MC connected to the one controller data word line CWL are external parities E#1 to E#n. The external parities E#1 to E#n are employed, in addition to the parities PU#1 and PL#1 to PU#n and PL#n, to correct the user data DU#1 and DL#1 to DU#n and DL#n. Now, the memory cells MC connected to the controller data word line CWL store 2-value data (1 bit/cell) which is less than is stored in the memory cells MC connected to the memory data word lines MWL. Therefore, there is no distinction of upper page and lower page in the external parities stored in the memory cells MC connected to the controller data word line CWL. The external parities E#1 to E#n are sometimes referred to below as a common parity C.

Furthermore, the plurality of memory cells MC connected to the controller data word line CWL may also store a parity CP employed for correcting the common parity C.

[Write Operation and Error Correcting Operation]

When executing the read operation in the nonvolatile semiconductor memory device of the present embodiment, the user data and the parity are read from the memory data word line MWL and the controller data word line CWL, and error correction is executed.

For example, error correction using the parity PU#1 is executed on the read user data DU#1, and error correction using the parity PL#1 is executed on the read user data DL#1. Next, if the error correction using the parities PU#1 and PL#1 has not succeeded, then error correction is executed on the user data DU#1 and DL#1 using the external parity E#1.

Moreover, error correction is executed similarly also on the other read user data DU#2 and DL#2 to DU#n and DL#n.

At this time, error correction using the parity CP is executed beforehand on the common parity C (external parities E#1 to E#n).

[Advantages]

In a nonvolatile semiconductor memory device, when values of data stored in one memory cell MC is increased, a width of the threshold voltage distributions and a distance between the threshold voltage distributions become narrow, and reliability of stored data lowers. Therefore, when employing a memory cell storing multi-value data for the memory cell MC storing the user data, the user data must be accurately error-corrected.

In the nonvolatile semiconductor memory device of the present embodiment, error correction of the user data DU#1 and DL#1 to DU#n and DL#n is performed respectively using the parities PU#1 and PL#1 to PU#n and PL#n. If this error correction has not succeeded, then re-correction is performed using the external parities E#1 to E#n, whereby reliability of memory cell data is improved.

Now, in the nonvolatile semiconductor memory device of the present embodiment, stored data per one cell of the memory cell MC storing the common parity C (external parities E#1 to E#n) and the parity CP is less than stored data per one cell of the memory cell MC of the memory data word line MWL. Therefore, the memory cell MC storing the common parity C (external parities E#1 to E#n) and the parity CP has a higher reliability than the memory cell MC of the memory data word line MWL. Because error correction is performed using the common parity C (external parities E#1 to E#n) and the parity CP stored in this high-reliability memory cell MC, a more correct correction of the user data is performed.

### Other Example 1 of First Embodiment

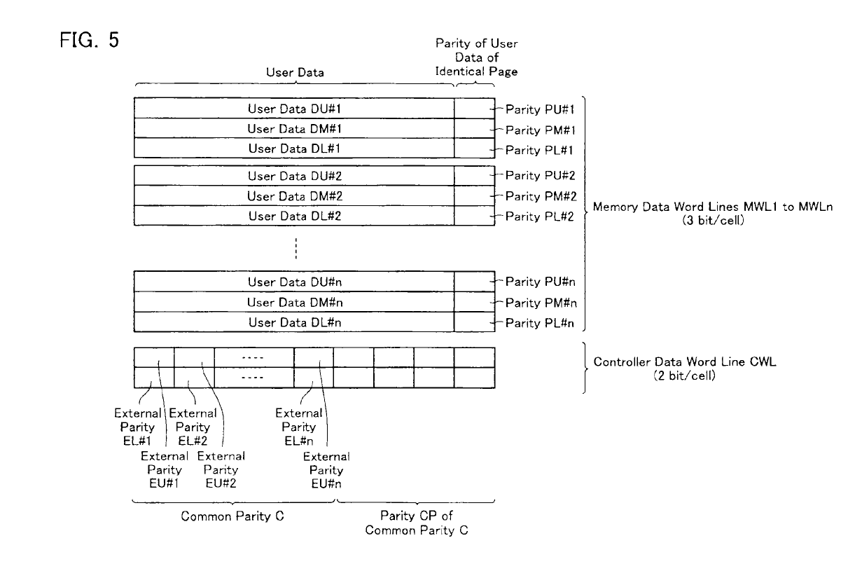

Next, another example of a storage state of data of the memory cell MC provided in the memory cell array 1 in the present embodiment will be described with reference to FIG. 5. FIG. 5 is a view explaining the storage state of data of the nonvolatile semiconductor memory device according to the present example.

In the present example also, the word lines WL provided in the memory cell array 1 are divided into two kinds of word lines. As shown in FIG. 5, some of the word lines WL provided in the memory cell array 1 are employed as memory data word lines MWL, and others of the word lines WL provided in the memory cell array 1 are employed as controller data word lines CWL.

In the present example also, a value (the number of bits) of stored data differs between the memory cells MC connected to the memory data word line MWL and the memory cells MC connected to the controller data word line CWL. In the present example, the memory cells MC connected to the memory data word line MWL store 8-value data (3 bits/cell). Moreover, the memory cells MC connected to the controller data word line CWL store 4-value data (2 bits/cell).

Stored in the plurality of memory cells MC connected to a certain one memory data word line MWL are, for example, user data DU#1, DM#1, and DL#1 and parities PU#1, PM#1 and PL#1. Now, the user data and parities stored in the memory cells MC connected to the memory data word line MWL are shown as the user data DU#1 and the parity PU#1 stored in an upper page, the user data DM#1 and the parity PM#1 stored in a middle page, and the user data DL#1 and the parity PL#1 stored in a lower page.

In the example shown in FIG. 5, stored respectively in the n memory data word lines MWL1 to MWLn are the user data DU#1, DM#1, and DL#1 and the parities PU#1, PM#1, and PL#1 to the user data DU#n, DM#n, and DL#n and the parities PU#n, PM#n, and PL#n.

Moreover, stored in the plurality of memory cells MC connected to the one controller data word line CWL are external parities EU#1 and EL#1 to EU#n and EL#n. The external parities EU#1 and EL#1 to EU#n and EL#n are employed, in addition to the parities PU#1, PM#1, and PL#1 to PU#n, PM#n, and PL#n, to correct the user data DU#1, DM#1, and DL#1 to DU#n, DM#1, and DL#n. Now, the memory cells MC connected to the controller data word line CWL store 4-value data (2 bits/cell) which is less than is stored by the memory cells MC connected to the memory data word lines MWL. Therefore, the external parities stored in the memory cells MC connected to the controller data word line CWL are shown as EU#1 to EU#n stored in an upper page and EL#1 to EL#n stored in a lower page.

The read operation and the error correcting operation of the nonvolatile semiconductor memory device of the present example are also performed similarly to in the above-described first embodiment. In the nonvolatile semiconductor memory device of the present example also, stored data per one cell of the memory cell MC storing the common parity C (external parities EU#1 and EL#1 to EU#n and EL#n) and the parity CP is less than stored data per one cell of the memory cell MC of the memory data word line MWL. Therefore, the memory cell MC storing the common parity C (external parities EU#1 and EL#1 to EU#n and EL#n) and the parity CP has a higher reliability than the memory cell MC of the memory data word line MWL. Because error correction is performed using the common parity C (external parities EU#1 and EL#1 to EU#n and EL#n) and the parity CP stored in this high-reliability memory cell MC, a more correct correction of the user data is performed.

### Other Example 2 of First Embodiment

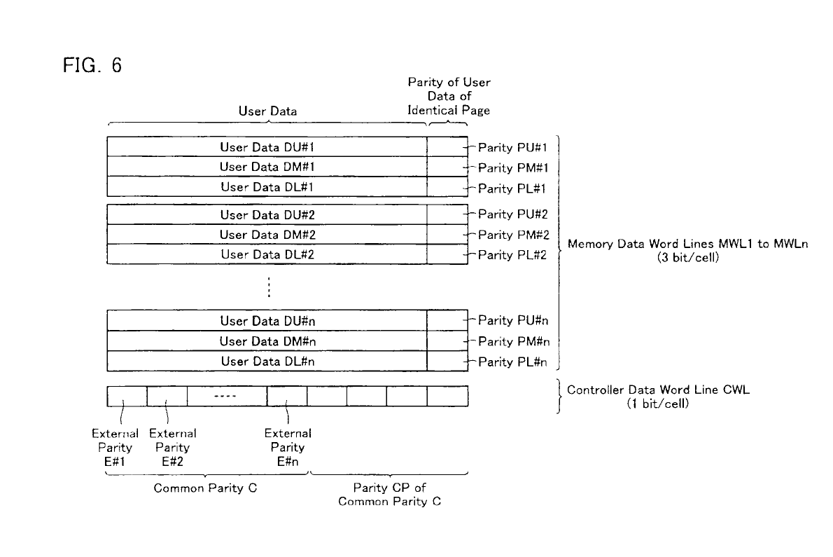

Next, another example of a storage state of data of the memory cell MC provided in the memory cell array 1 in the present embodiment will be described with reference to FIG. 6. FIG. 6 is a view explaining the storage state of data of the nonvolatile semiconductor memory device according to the present example.

In the present example also, the word lines WL provided in the memory cell array 1 are divided into two kinds of word lines. As shown in FIG. 6, some of the word lines WL provided in the memory cell array 1 are employed as memory data word lines MWL, and others of the word lines WL provided in the memory cell array 1 are employed as controller data word lines CWL.

In the present example also, a value (the number of bits) of stored data differs between the memory cell MC connected to the memory data word line MWL and the memory cell MC connected to the controller data word line CWL. In the present example, the memory cell MC connected to the memory data word line MWL stores 8-value data (3 bitd/cell). Moreover, the memory cell MC connected to the controller data word line CWL stores 2-value data (1 bit/cell).

Stored in the plurality of memory cells MC connected to a certain one memory data word line MWL are, for example, user data DU#1, DM#1, and DL#1 and parities PU#1, PM#1 and PL#1. Now, the user data and parities stored in the memory cell MC connected to the memory data word line MWL are shown as the user data DU#1 and the parity PU#1 stored in an upper page, the user data DM#1 and the parity PM#1 stored in a middle page, and the user data DL#1 and the parity PL#1 stored in a lower page.

In the example shown in FIG. 6, stored respectively in the n memory data word lines MWL1 to MWLn are the user data DU#1, DM#1, and DL#1 and the parities PU#1, PM#1, and PL#1 to the user data DU#n, DM#n, and DL#n and the parities PU#n, PM#n, and PL#n.

Moreover, stored in the plurality of memory cells MC connected to the one controller data word line CWL are external parities E#1 to E#n. The external par ties E#1 to E#n are employed, in addition to the parities PU#1, PM#1, and PL#1 to PU#n, PM#n, and PL#n, to correct the user data DU#1, DM#1, and DL#1 to DU#n, DM#1, and DL#n. Now, the memory cells MC connected to the controller data word line CWL hold 2-value data (1 bit/cell) which is less than is stored by the memory cells MC connected to the memory data word lines MWL. Therefore, there is no distinction of upper page and lower page in the external parities stored in the memory cells MC connected to the controller data word line CWL.

The read operation and the error correcting operation of the nonvolatile semiconductor memory device of the present example are also performed similarly to in the above-described first embodiment. In the nonvolatile semiconductor memory device of the present example also, stored data per one cell of the memory cell MC storing the common parity C (external parities E#1 to E#n) and the parity CP is less than stored data per one cell of the memory cell MC of the memory data word line MWL. Therefore, the memory cell MC storing the common parity C (external parities E#1 to E#n) and the parity CP has a higher reliability than the memory cell MC of the memory data word line MWL. Because error correction is performed using the common parity C (external parities E#1 to E#n) and the parity CP stored in this high-reliability memory cell MC, a more correct correction of the user data is performed.

[Other]

In the above description, a value of data (the number of bits) stored in the memory cells MC connected to the memory data word line MWL is of only one type, and a value of data (the number of bits) stored in the memory cells MC connected to the controller data word line CWL is of only one type. However, the of values of stored data is not limited to one type, provided that the values of data stored in the memory cells MC connected to the controller data word line CWL is smaller than the number of values of data stored in the memory cells MC connected to the memory data word line MWL. For example, the memory cells MC connected to the memory data word line MWL may store 8-value data (3 bits/cell) and the memory cell MC connected to the controller data word line CWL may store 4-value data (2 bits/cell) or 2-value data (1 bit/cell)

### Second Embodiment

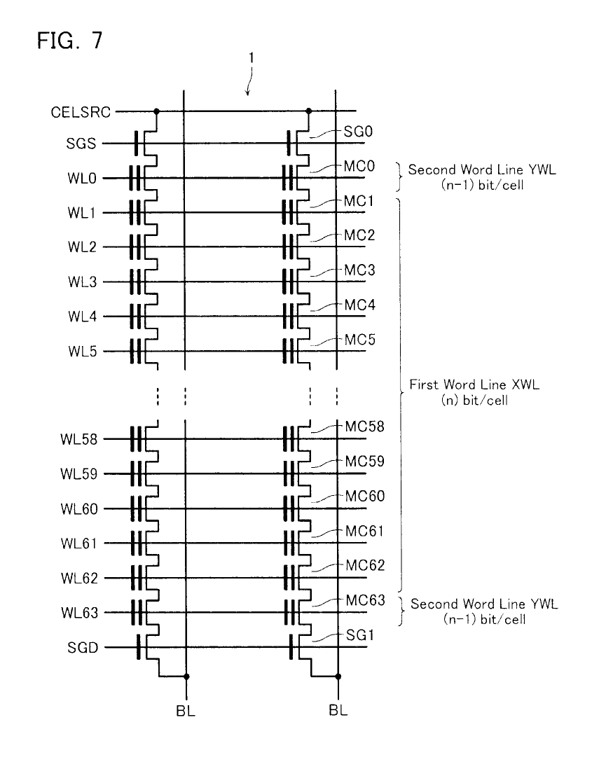

Next, a second embodiment will be described with reference to FIG. 7. An overall configuration of a nonvolatile semiconductor memory device of the second embodiment is similar to that of the first embodiment, and a detailed description thereof will be omitted. Moreover, places having a similar configuration to those in the first embodiment are assigned with identical reference symbols, and a duplicated description of such places will be omitted.

In this embodiment, arrangement within the memory cell array 1 of the memory cells MC having different values (numbers of bits) of stored data, will be described. The configuration of the memory cell array 1 of the nonvolatile semiconductor memory device according to the present embodiment will be described below with reference to FIG. 7.

[Configuration of Memory Cell Array 1]

FIG. 7 is a circuit diagram showing the memory cell array 1 of the nonvolatile semiconductor memory device according to the present embodiment. As shown in FIG. 7, the word lines WL0 to WL63 provided in the memory cell array 1 are divided into two kinds of word lines, that is, first word lines XWL and second word lines YWL.

The memory cells MC connected to the first word lines XWL and the memory cells MC connected to the second word lines YWL differ in values (number of bits) of data stored therein. The memory cells MC connected to the first word lines XWL store (n) bits of data, while the memory cells MC connected to the second word lines YWL store fewer bits, i.e., (n−1) bits of data.

For example, the memory cells MC connected to the first word lines XWL may store four-value data (2 bits/cell), and the memory cells MC connected to the second word lines YWL may store binary data (1 bit/cell) In addition, for example, the memory cells MC connected to the first word lines XWL may store eight-value data (3 bits/cell), and the memory cells MC connected to the second word lines YWL may store four-value data (2 bits/cell).

Now, in the nonvolatile semiconductor memory device of the present embodiment, the memory cell array 1 is configured such that as the word line WL is closer to a select gate line SGS or SGD, the values (number of bits) of data stored in the memory cell MC connected to the word line WL becomes smaller. As shown in FIG. 7, the word lines WL0 and WL 63 which are adjacent to the select gate lines SGS and SGD and are closest to the select gate lines SGS and SGD are used as the second word lines YWL whose corresponding memory cells MC store (n−1) bits of data. The other word lines WL1 to WL62 are used as the first word lines XWL whose corresponding memory cells MC store (n) bits of data.

[Advantages]

In a nonvolatile semiconductor memory device, memory cells MC connected to a word line WL close to a select gate line SGS or SGD easily deteriorate under the influence of a voltage provided to select gate transistors SG0, SG1 and the like. In addition, when the values of data (number of bits) stored in one memory cell MC is increased, a width of the threshold voltage distributions and a distance between the threshold voltage distributions become narrow, and reliability of data stored therein lowers.

When the values of data (the numbers of bits) to be stored in one memory cell are made identical, reliability of data stored therein differs greatly between the memory cells MC which are close to the select gate lines SGS and SGD and the memory cells MC which are far from the select gate lines SGS and SGD, due to the influence of deterioration.

In contrast, in the nonvolatile semiconductor memory device of the present embodiment, the memory cell array 1 is configured such that that as the word line WL is closer to a select gate line SGS or SGD, the values (number of bits) of data stored in the memory cell MC connected to the word line WL becomes smaller. Because the values (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

### Other Example 1 of Second Embodiment

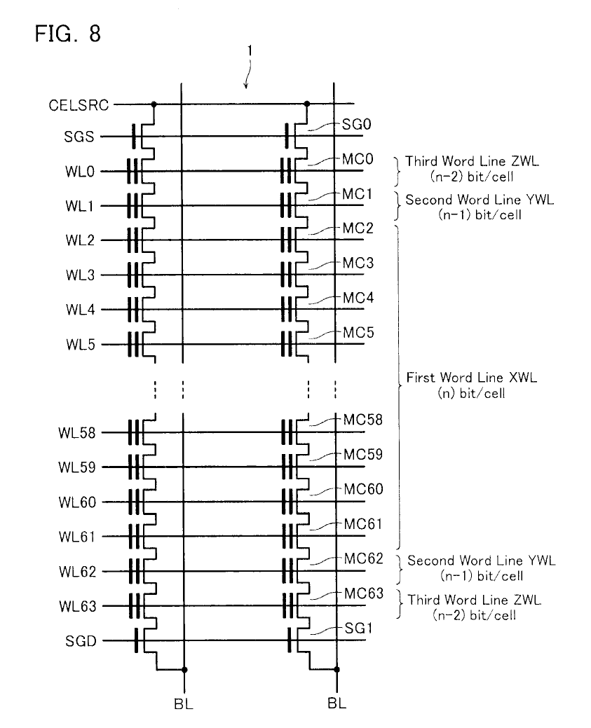

Next, another example of configuration of the memory cell array 1 of the nonvolatile semiconductor memory device according to the present embodiment will be described with reference to FIG. 8. FIG. 8 is a circuit diagram showing the memory cell array 1 of the nonvolatile semiconductor memory device according to the present example. As shown in FIG. 8, the word lines WL0 to WLE3 provided in the memory cell array 1 are divided into three kinds of word lines, that is, first word lines XWL, second word lines YWL, and third word lines ZWL.

The memory cells MC connected to the first word lines XWL, the memory cells MC connected to the second word lines YWL, and the memory cells connected to the third word lines ZWL differ in the values (number of bits) of data stored therein. The memory cells MC connected to the first word lines XWL store (n) bits of data, the memory cells MC connected to the second word lines YWL store fewer bits, i.e., (n−1) bits of data, and the memory cells MC connected to the third word lines ZWL store even fewer bits, i.e., (n−2) bits of data.

For example, the memory cells MC connected to the first word lines XWL may store eight-value data (3 bits/cell), the memory cells MC connected to the second word lines YWL may store four-value data (2 bits/cell), and the memory cells MC connected to the third word lines ZWL may store binary data (1 bit/cell).

Now, in the nonvolatile semiconductor memory device of the present embodiment, the memory cell array 1 is configured such that as the word line WL is closer to a select gate line SGS or SGD, the values (number of bits) of data stored in the memory cell MC connected to the word line WL becomes smaller. As shown in FIG. 8, the word lines WL0 and WL 63 which are adjacent to the select gate lines SGS and SGD and are closest to the select gate lines SGS and SGD are used as the third word lines ZWL whose corresponding memory cells MC store (n−2) bits of data. The word lines WL1 and WL62 which are next closest to the select gate lines SGS and SGD are used as the second word lines YWL whose corresponding memory cells MC store (n−1) bits of data. The other word lines WL2 to WL61 are used as the first word lines XWL whose corresponding memory cells MC store (n) bits of data.

Also in the nonvolatile semiconductor memory device of the present example, the memory cell array 1 is configured such that that as the word line WL is closer to a select gate line SGS or SGD, the values (number of bits) of data stored in the memory cell MC connected to the word line WL becomes smaller. Because the values (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

[Other]

In the above description, it has been explained that the number of the second word lines YWL or third word lines ZWL is one, respectively. The number of the second word lines YWL or third word lines ZWL is not limited to one, and a plurality of the second word lines YWL or third word lines ZWL may be provided. It is only required to configure such that as the word line WL is closer to a select gate line SGS or SGD, the values of data stored in the memory cell MC connected to the word line WL becomes smaller.

### Third Embodiment

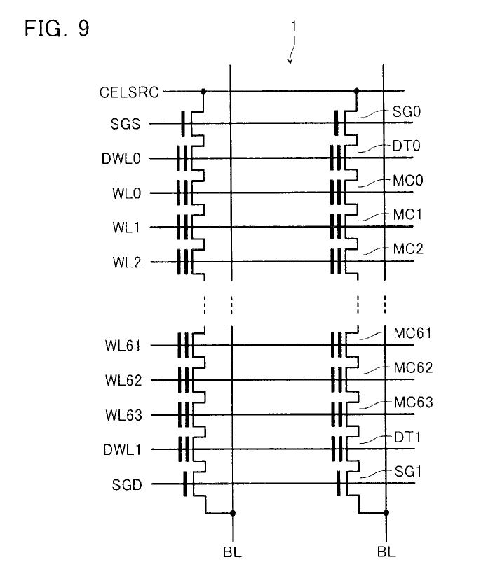

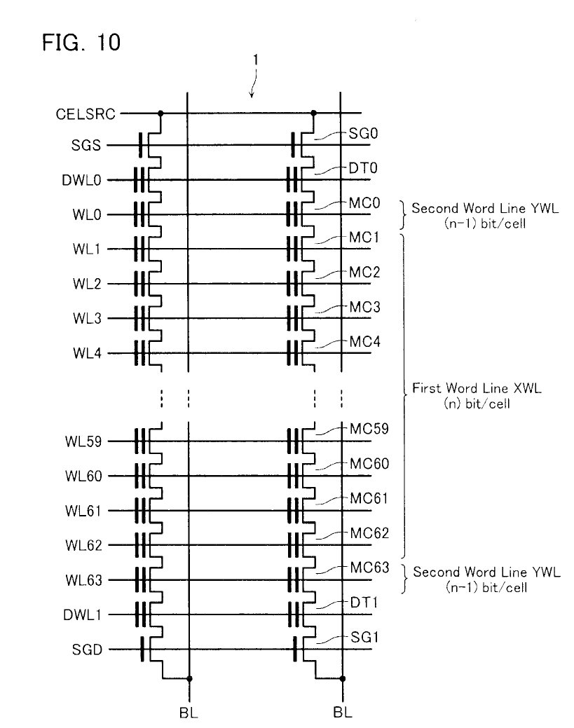

Next, a third embodiment will be described with reference to FIGS. 9 and 10. An overall configuration of a nonvolatile semiconductor memory device of the third embodiment is similar to that of the first embodiment, and a detailed description thereof will be omitted. Moreover, places having a similar configuration to those in the first embodiment are assigned with identical reference symbols, and a duplicated description of such places will be omitted.

The present embodiment differs from the second embodiment in having provided in a memory cell array 1 thereof a dummy word line connected to a non-data-storing dummy transistor. The configuration of the memory cell array 1 of the nonvolatile semiconductor memory device according to the present embodiment will be described below with reference to FIGS. 9 and 10.

[Configuration of Dummy Transistor and Dummy Word Line]

FIG. 9 is a circuit diagram showing the memory cell array 1 of the nonvolatile semiconductor memory device according to the present embodiment.

In the memory cell array 1, dummy transistors DT0 and DT1 are respectively connected to both ends of a memory string configured by the memory cells MC0 to MC63. Gate electrodes of the dummy transistors DT0 and DT1 are connected to dummy word lines DWL0 and DWL1. Now, the number of dummy transistors DT connected to one end of the memory string is not limited to one, and any number of dummy transistors DT may be provided. The dummy word lines DWL are driven by the row decoder/word line driver 2a.

The dummy transistors DT0 and DT1 are provided in view of deterioration of transistors close to the select gate transistors SG0 and SG1. These dummy transistors DT0 and DT1 are not used in storage of user data and parities.

[Configuration of Memory Cell Array 1]

FIG. 10 is a circuit diagram showing the memory cell array 1 of the nonvolatile semiconductor memory device according to the present embodiment. As shown in FIG. 10, the word lines WL0 to WL63 provided in the memory cell array 1 are divided into two kinds of word lines, that is, first word lines XWL and second word lines YWL.

Similarly to in the second embodiment, in the nonvolatile semiconductor memory device according to the present embodiment also, the memory cells MC connected to the first word lines XWL and the memory cells MC connected to the second word lines YWL differ in the values (number of bits) of data stored therein. The memory cells MC connected to the first word lines XWL store (n) bits of data, while the memory cells MC connected to the second word lines YWL store fewer bits, i.e., (n−1) bits of data.

For example, the memory cells MC connected to the first word lines XWL may store four-value data (2 bits/cell), and the memory cells MC connected to the second word lines YWL may store binary data (1 bit/cell). In addition, for example, the memory cells MC connected to the first word lines XWL may store eight-value data (3 bits/cell), and the memory cells MC connected to the second word lines YWL may store four-value data (2 bits/cell).

Now, in the nonvolatile semiconductor memory device of the present embodiment, the memory cell array 1 is configured such that as the word line WL is closer to a select gate line SGS or SGD, the values (number of bits) of data stored in the memory cell MC connected to the word line WL becomes smaller. As shown in FIG. 10, the word lines WL0 and WL 63 which are adjacent to the select gate lines SGS and SGD and are closest to the select gate lines SGS and SGD are used as the second word lines YWL whose corresponding memory cells MC store (n−1) bits of data. The other word lines WL1 to WL62 are used as the first word lines XWL whose corresponding memory cells MC store (n) bits of data.

[Advantages]

In the nonvolatile semiconductor memory device of the present embodiment, the memory cell array 1 is configured such that that as the word line WL is closer to a select gate line SGS or SGD, the values (number of bits) of data stored in the memory cell MC connected to the word line WL becomes smaller. Because the values (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

Moreover, in the nonvolatile semiconductor memory device of the present embodiment, the dummy word lines DWL0 and DWL1 are disposed at positions adjacent to the select gate lines SGS and SGD. The dummy transistors DT0 and DT1 disposed at positions adjacent to the select gate transistors SG0 and SG1 are not used in storage of user data or the like, hence even if deteriorated, there is never any influence exerted on reliability of read data.

### Other Example 1 of Third Embodiment

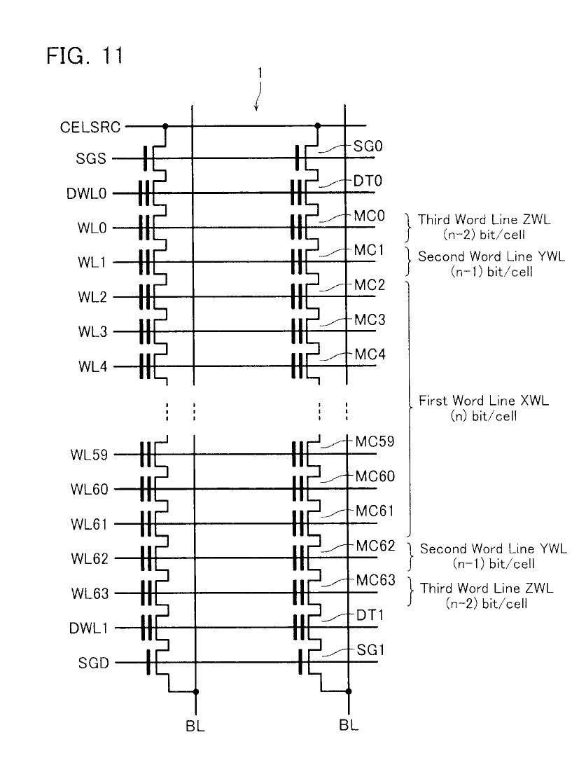

Next, another example of configuration of the memory cell array 1 of the nonvolatile semiconductor memory device according to the present embodiment will be described with reference to FIG. 11. FIG. 11 is a circuit diagram showing the memory cell array of the nonvolatile semiconductor memory device according to the present example. As shown in FIG. 11, the word lines WL0 to WL63 provided in the memory cell array 1 are divided into three kinds of word lines, that is, first word lines XWL, second word lines YWL, and third word lines ZWL.

Similarly to in the second embodiment, in the nonvolatile semiconductor memory device of the present example also, the memory cells MC connected to the first wordlines XWL, the memory cells MC connected to the second word lines YWL, and the memory cells connected to the third word lines ZWL differ in the values (number of bits) of data stored therein. The memory cells MC connected to the first word lines XWL store (n) bits of data, the memory cells MC connected to the second word lines YWL store fewer bits, i.e., (n−1) bits of data, and the memory cells MC connected to the third word lines ZWL store even fewer bits, i.e., (n−2) bits of data.

For example, the memory cells MC connected to the first word lines XWL may store eight-value data (3 bits/cell), the memory cells MC connected to the second word lines YWL may store four-value data (2 bits/cell), and the memory cells MC connected to the third word lines ZWL may store binary data (1 bit/cell).

Now, in the nonvolatile semiconductor memory device of the present embodiment, the memory cell array 1 is configured such that as the word line WL is closer to a select gate line SGS or SGD, the values (number of bits) of data stored in the memory cell MC connected to the word line WL becomes smaller. As shown in FIG. 11, the word lines WL0 and WL 63 which are adjacent to the select gate lines SGS and SGD and are closest to the select gate lines SGS and SGD are used as the third word lines ZWL whose corresponding memory cells MC store (n−2) bits of data. The word lines WL1 and WL62 which are next closest to the select gate lines SGS and SGD are used as the second word lines YWL whose corresponding memory cells MC store (n−1) bits of data. The other word lines WL2 to WL61 are used as the first word lines XWL whose corresponding memory cells MC store (n) bits of data.

In the nonvolatile semiconductor memory device of the present example also, the memory cell array 1 is configured such that that as the word line WL is closer to a select gate line SGS or SGD, the values (number of bits) of data stored in the memory cell MC connected to the word line WL becomes smaller. Because the values (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

Moreover, in the nonvolatile semiconductor memory device of the present example, the dummy word lines DWL0 and DWL1 are disposed at positions adjacent to the select gate lines SGS and SGD. The dummy transistors DT0 and DT1 disposed at positions adjacent to the select gate transistors SG0 and SG1 are not used in storage of user data or the like, hence even if deteriorated, there is never any influence exerted on reliability of read data.

### Fourth Embodiment

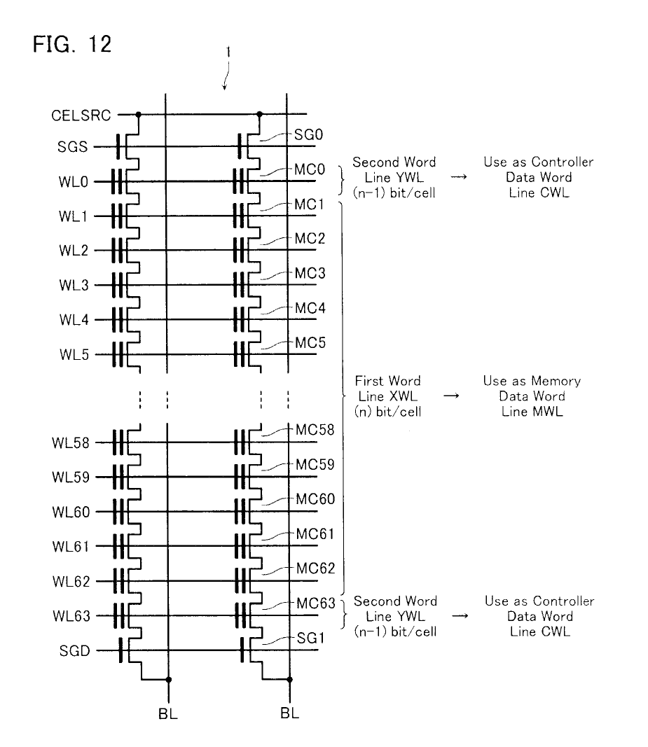

Next, a fourth embodiment will be described with reference to FIG. 12. An overall configuration of a nonvolatile semiconductor memory device of the fourth embodiment is similar to that of the first embodiment, and a detailed description thereof will be omitted. Moreover, places having a similar configuration to those in the first embodiment are assigned with identical reference symbols, and a duplicated description of such places will be omitted.

The present embodiment describes a combination of the first embodiment and the second embodiment. In the first embodiment, the word lines WL were used as either memory data word lines MWL or controller data word lines CWL configured to store different data. Moreover, the second embodiment described disposition within the memory cell array of the memory cells MC having different values (numbers of bits) of stored data. In the present embodiment, these configurations are used in combination. The configuration of the memory cell array 1 of the nonvolatile semiconductor memory device according to the present embodiment will be described below with reference to FIG. 12.

[Configuration of Memory Cell Array 1]

FIG. 12 is a circuit diagram showing the memory cell array 1 of the nonvolatile semiconductor memory device according to the present embodiment. As shown in FIG. 12, the word lines WL0 to WL63 provided in the memory cell array 1 are divided into two kinds of word lines, that is, first word lines XWL and second word lines YWL. Configuration and disposition of these first word lines XWL and second word lines YWL are similar to in the second embodiment (FIG. 7), hence a description thereof will be omitted.

Now, in the nonvolatile semiconductor memory device of the present embodiment, the first word lines XWL are used as the memory data word lines MWL storing the user data and parities. Moreover, the second word lines YWL are used as the controller data word lines CWL storing the common parity and the parity for the common parity. Data storage states of the memory data word lines MWL and the controller data word lines CWL are similar to in the first embodiment, hence a description thereof will be omitted.

[Advantages]

In the nonvolatile semiconductor memory device of the present embodiment, the memory cell array 1 is configured such that as the word line WL is closer to a select gate line SGS or SGD, the value (number of bits) of data stored in the memory cell MC connected to the word line WL becomes smaller. Because the value (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

In the nonvolatile semiconductor memory device of the present embodiment, the controller data word lines CWL storing the common parity C and the parity CP are provided close to the select gate lines SGS and SGD. The memory cells MC connected to the controller data word lines CWL can maintain reliability even when deteriorated, because the value (number of bits) of data stored therein is small. Reliability of correction of the user data can be secured even when performing error correction using the common parity C and the parity CP stored in the memory cells MC connected to this controller data word line CWL.

### Other Example 1 of Fourth Embodiment

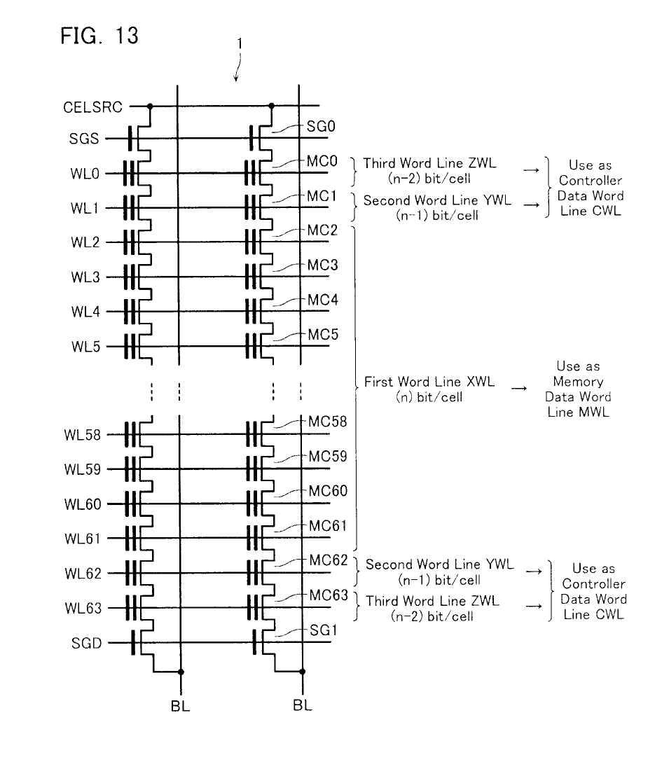

Next, another example of configuration of the memory cell array 1 of the nonvolatile semiconductor memory device according to the present embodiment will be described with reference to FIG. 13. FIG. 13 is a circuit diagram showing the memory cell array 1 of the nonvolatile semiconductor memory device according to the present example. As shown in FIG. 13, the word lines WL0 to WL63 provided in the memory cell array 1 are divided into three kinds of word lines, that is, first word lines XWL, second word lines YWL, and third word lines ZWL. Configuration and disposition of these first word lines XWL, second word lines YWL, and third word lines ZWL are similar to in the other example 1 of the second embodiment (FIG. 8), hence a description thereof will be omitted.

Now, in the nonvolatile semiconductor memory device of the present example, the first word lines XWL are used as the memory data word lines MWL storing the user data and parities. Moreover, the second word lines YWL and third word lines ZWL are used as the controller data word lines CWL storing the common parity and the parity for the common parity. Data storage states of the memory data word lines MWL and the controller data word lines CWL are similar to in the first embodiment, hence a description thereof will be omitted.

[Advantages]

In the nonvolatile semiconductor memory device of the present example, the memory cell array 1 is configured such that as the word line WL is closer to a select gate line SGS or SGD, the value (number of bits) of data stored in the memory cell MC connected to the word line WL becomes smaller. Because the value (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

In the nonvolatile semiconductor memory device of the present example, the controller data word lines CWL storing the common parity C and the parity CP are provided close to the select gate lines SGS and SGD. The memory cells MC connected to the controller data word lines CWL can maintain reliability even when deteriorated, because the value (number of bits) of data stored therein is small. Reliability of correction of the user data can be secured even when performing error correction using the common parity C and the parity CP stored in the memory cells MC connected to this controller data word line CWL.

### Fifth Embodiment

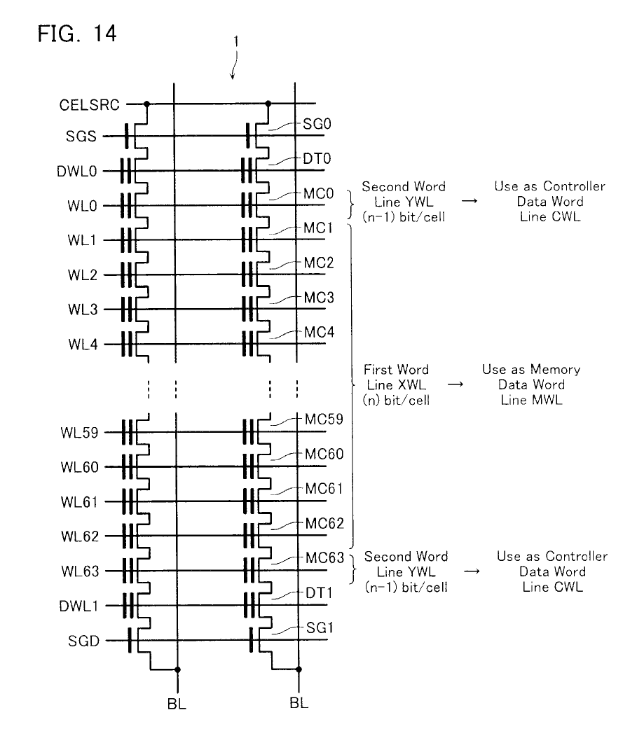

Next, a fifth embodiment will be described with reference to FIG. 14. An overall configuration of a nonvolatile semiconductor memory device of the fifth embodiment is similar to that of the first embodiment, and a detailed description thereof will be omitted. Moreover, places having a similar configuration to those in the first embodiment are assigned with identical reference symbols, and a duplicated description of such places will be omitted.

The present embodiment describes a combination of the first embodiment and the third embodiment. In the first embodiment, the word lines WL were used as either memory data word lines MWL or controller data word lines CWL configured to store different data. Moreover, the third embodiment described disposition within the memory cell array 1 of the memory cells MC having different values (numbers of bits) of stored data. In the present embodiment, these configurations are used in combination. The configuration of the memory cell array 1 of the nonvolatile semiconductor memory device according to the present embodiment will be described below with reference to FIG. 14.

[Configuration of Memory Cell Array 1]

FIG. 14 is a circuit diagram showing the memory cell array 1 of the nonvolatile semiconductor memory device according to the present embodiment. As shown in FIG. 14, dummy word lines DWL0 and DWL1 are provided in the memory cell array 1. Moreover, the word lines WL0 to WL63 provided in the memory cell array 1 are divided into two kinds of word lines, that is, first word lines XWL and second word lines YWL. Configuration and disposition of these first word lines XWL and second word lines YWL are similar to in the third embodiment (FIG. 10), hence a description thereof will be omitted.

Now, in the nonvolatile semiconductor memory device of the present embodiment, the first word lines XWL are used as the memory data word lines MWL storing the user data and parities. The second word lines YWL are used as the controller data word lines CWL storing the common parity and the parity for the common parity. Data storage states of the memory data word lines MWL and the controller data word lines CWL are similar to in the first embodiment, hence a description thereof will be omitted.

[Advantages]

In the nonvolatile semiconductor memory device of the present embodiment, the memory cell array 1 is configured such that as the word line WL is closer to a select gate line SGS or SGD, the value (number of bits) of data stored in the memory cell MC connected to the word line WL becomes smaller. Because the value (number of bits) of data stored in the memory cell MC connected to the word line WL close to the select gate line SGS or SGD is small, reliability of data never differs greatly between said memory cell MC, even when deteriorated, and the memory cell MC which is far from the select gate line SGS or SGD. Therefore, reliability of memory cell data is made uniform.

Moreover, in the nonvolatile semiconductor memory device of the present embodiment, the dummy word lines DWL0 and DWL1 are disposed at positions adjacent to the select gate lines SGS and SGD. The dummy transistors DT0 and DT1 disposed at positions adjacent to the select gate transistors SG0 and SG1 are not used in storage of user data or the like, hence even if deteriorated, there is never any influence exerted on reliability of read data.

In the nonvolatile semiconductor memory device of the present embodiment, the controller data word lines CWL storing the common parity C and the parity CP are provided close to the select gate lines SGS and SGD via the dummy word lines DWL0 and DWL1. The memory cells MC connected to the controller data word lines CWL can maintain reliability even when deteriorated, because the value (number of bits) of data stored therein is small. Moreover, providing the dummy word lines DWL0 and DWL1 also makes it possible to reduce the influence of deterioration of the memory cells MC. Reliability of correction of the user data can be secured even when performing error correction using the common parity C and the parity CP stored in the memory cells MC connected to this controller data word line CWL.

### Other Example 1 of Fifth Embodiment

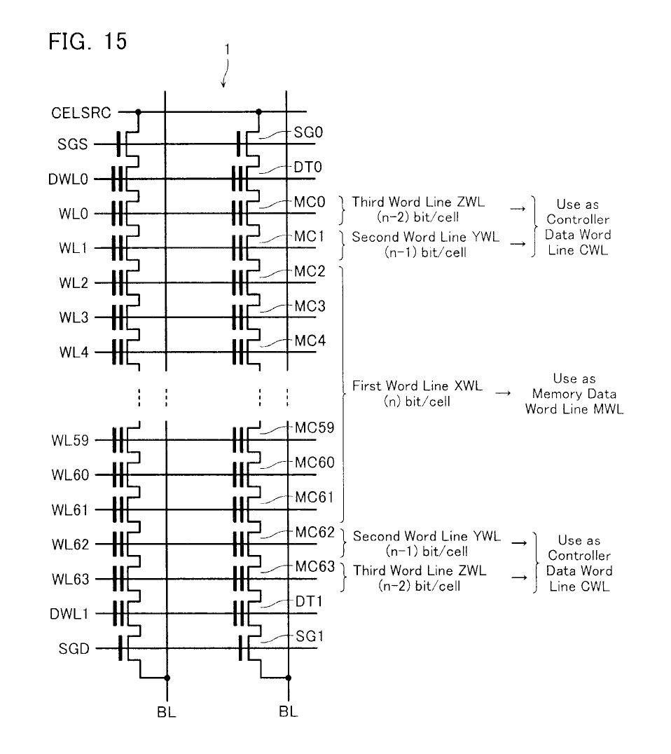

Next, another example of configuration of the memory cell array 1 of the nonvolatile semiconductor memory device according to the present embodiment will be described with reference to FIG. 15. FIG. 15 is a circuit diagram showing the memory cell array 1 of the nonvolatile semiconductor memory device according to the present example. As shown in FIG. 15, dummy word lines DWL0 and DWL1 are provided in the memory cell array 1. Moreover, the word lines WL0 to WL63 provided in the memory cell array 1 are divided into three kinds of word lines, that is, first word lines XWL, second word lines YWL, and third word lines ZWL. Configuration and disposition of these first word lines XWL, second word lines YWL, and third word lines ZWL are similar to in the other example 1 of the third embodiment (FIG. 11), hence a description thereof will be omitted.

Now, in the nonvolatile semiconductor memory device of the present example, the first word lines XWL are used as the memory data word lines MWL storing the user data and parities. Moreover, the second word lines YWL and third word lines ZWL are used as the controller data word lines CWL storing the common parity and the parity for the common parity. Data storage states of the memory data word lines MWL and the controller data word lines CWL are similar to in the first embodiment, hence a description thereof will be omitted.

[Advantages]

In the nonvolatile semiconductor memory device of the present example also, the controller data word lines CWL storing the common parity C and the parity CP are provided close to the select gate lines SGS and SGD via the dummy word lines DWL0 and DWL1. The memory cells MC connected to the controller data word lines CWL can maintain reliability even when deteriorated, because the value (number of bits) of data stored therein is small. Moreover, providing the dummy word lines DWL0 and DWL1 also makes it possible to reduce the influence of deterioration of the memory cells MC. Reliability of correction of the user data can be secured even when performing error correction using the common parity C and the parity CP stored in the memory cells MC connected to this controller data word line CWL.

[Other]

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the above-described embodiments, the values of data stored in the memory cell MC were described as 8-value (3 bits/cell), 4-value (2 bits/cell), and binary (1 bit/cell). However, other values are also possible.

What is claimed is:

1. A nonvolatile semiconductor memory device, comprising:
a memory cell array having a plurality of NAND strings arranged therein, each of the NAND strings including a memory string having a plurality of memory cells connected in series therein and a first select transistor and a second select transistor respectively connected to both ends of the memory string;
a plurality of word lines respectively connected to control gate electrodes of the plurality of memory cells;
a plurality of select gate lines respectively connected to control gate electrodes of the first select transistor and the second select transistor; and
a control circuit that controls data stored in the plurality of memory cells,
the word line including a first word line which is connected to the memory cell configured capable of storing data of a first bit number and a second word line which is connected to the memory cell configured capable of storing data of a second bit number which is smaller than the first bit number,
the control circuit being configured to store in the memory cell connected to the first word line user data capable of being arbitrarily rewritten by a user and a parity for performing error correction on the user data, and
the control circuit being configured to store in the memory cell connected to the second word line not only the parity but also a first external parity for performing error correction on the user data.

2. The nonvolatile semiconductor memory device according to claim 1, wherein
the second bit number is one bit.

3. The nonvolatile semiconductor memory device according to claim 1, wherein
the second bit number is multiple bits.

4. The nonvolatile semiconductor memory device according to claim 1, wherein
the control circuit is configured to store in the memory cell connected to the second word line a second external parity for performing error correction on the first external parity.

5. A nonvolatile semiconductor memory device, comprising:
a memory cell array having a plurality of NAND strings arranged therein, each of the NAND strings including a memory string having a plurality of memory cells connected in series therein and a first select transistor and a second select transistor respectively connected to both ends of the memory string;
a plurality of word lines respectively connected to control gate electrodes of the plurality of memory cells;
a plurality of select gate lines respectively connected to control gate electrodes of the first select transistor and the second select transistor; and
a control circuit that controls data stored in the plurality of memory cells,
the memory cell array being configured such that as the word line is the closer to the select gate line, a bit number of data stored in the memory cell connected to the word line decreases.

6. The nonvolatile semiconductor memory device according to claim 5, wherein
the word line includes a first word line which is connected to the memory cell configured capable of storing data of a first bit number and a second word line which is connected to the memory cell configured capable of holding data of a second bit number which is smaller than the first bit number, and
the second word line is provided adjacent to the select gate line.

7. The nonvolatile semiconductor memory device according to claim 6, wherein
the control circuit is configured to store in the memory cell connected to the first word line user data capable of being arbitrarily rewritten by a user and a parity for performing error correction on the user data.

8. The nonvolatile semiconductor memory device according to claim 6, wherein
the control circuit is configured to store in the memory cell connected to the second word line not only the parity but also a first external parity for performing error correction on the user data.

9. The nonvolatile semiconductor memory device according to claim 5, wherein
the word line includes a first word line which is connected to the memory cell configured capable of storing data of a first bit number, a second word line which is connected to the memory cell configured capable of storing data of a second bit number which is smaller than the first bit number, and a third word line which is connected to the memory cell configured capable of storing data of a third bit number which is smaller than the second bit number, and
the third word line is provided adjacent to the select gate line.

10. The nonvolatile semiconductor memory device according to claim 9, wherein
the second word line is provided adjacent to the third word line.

11. The nonvolatile semiconductor memory device according to claim 9, wherein
the control circuit is configured to store in the memory cell connected to the first word line user data capable of being arbitrarily rewritten by a user and a parity for performing error correction on the user data.

12. The nonvolatile semiconductor memory device according to claim 9, wherein
the control circuit is configured to store in the memory cell connected to the second word line and the third word line not only the parity but also a first external parity for performing error correction on the user data.

13. The nonvolatile semiconductor memory device according to claim 5, further comprising:
a dummy transistor provided between one end of the memory string and the first select transistor and between the other end of the memory string and the second select transistor.

14. A control method of a nonvolatile semiconductor memory device, the nonvolatile semiconductor memory device comprising:
a memory cell array having a plurality of NAND strings arranged therein, each of the NAND strings including a memory string having a plurality of memory cells connected in series therein and a first select transistor and a second select transistor respectively connected to both ends of the memory string;
a plurality of word lines respectively connected to control gate electrodes of the plurality of memory cells; and
a plurality of select gate lines respectively connected to control gate electrodes of the first select transistor and the second select transistor, and
the word line including a first word line which is connected to the memory cell configured capable of storing data of a first bit number and a second word line which is connected to the memory cell configured capable of storing data of a second bit number which is smaller than the first bit number,
the control method comprising:
reading from the memory cell connected to the first word line user data capable of being arbitrarily rewritten by a user and a parity for performing error correction on the user data;
reading from the memory cell connected to the second word line not only the parity but also a first external parity for performing error correction on the user data; and
executing error correction of the user data using the parity and the first external parity.

15. The control method of a nonvolatile semiconductor memory device according to claim 14, wherein
the second bit number is one bit.

16. The control method of a nonvolatile semiconductor memory device according to claim 14, wherein
the second bit number is multiple bits.

17. The control method of a nonvolatile semiconductor memory device according to claim 14, further comprising
reading from the memory cell connected to the second word line a second external parity for performing error correction on the first external parity.
